(19) United States
(12) Patent Application Publication
(10) Pub. No.: US 2001/0029779 A1
(43) Pub. Date: Oct. 18, 2001

(54) Engine suspension for a test bed

(76) Inventors: Robert Malbrouck, Alleur (BE); Gerard Guillet, Vivegnis (BE); Vincent Meijnen, Longpre (BE)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/809,806

(22) Filed: Mar. 16, 2001

(30) Foreign Application Priority Data
Mar. 17, 2000 (EP) 00 870 047.8

(51) Int. Cl. G01M 19/00; G01L 3/26

(52) U.S. Cl. 73/116; 73/118.1

(57) ABSTRACT

The present invention relates to a suspension device for an engine on a ground test bed, this bed comprising a fixed frame and an engine support structure, the said suspension device forming the connection between the fixed frame of the test bed and the engine support structure, characterized in that it comprises at least one member having elastic behaviour and comprising at least one block made of an elastomeric material.

### SUBJECT OF THE INVENTION

The present invention relates to an engine suspension for a ground test bed.

### PRIOR ART

Engines such as turboprop engines and turbojet engines have to be subjected to a series of tests on test beds in order to be able to check their mechanical and aerodynamic characteristics and behaviour. These engines are arranged and maintained on these test beds with the aid of a support structure. These engines are subjected to a series of tests and inspections such as running-in, checking the thrust, consumption, absence of vibrations, inspecting the fuel pumps, the starting-air circuit, the charging of the spark plugs, the condition of the doors and flaps, the ancillary circuits and safety circuits, etc.

During inspection of the said engine, it is exposed to working conditions which are such that they generate vibrations. These may be, on the one hand, natural vibrations of the normal running of the engine and of the engine support structure, and, on the other hand, point vibrations due to an incident such as, for example, the breaking of a fan rotor blade or the blocking of the rotor caused, for example, by the deterioration of a bearing.

In order to prevent there from being any transfer of the vibrations from the said engine (risk of resonance) to the test bed frame, solutions have been proposed which are based either on the torsion of metal members such as torsion bars, or on the presence of a relatively deformable support structure.

However, it has been found that the suspensions proposed will be different for each type of engine and that they will have to be adapted as a function of the particular type of engine to be tested.

In addition, this type of solution has the following drawbacks: considerable bulk, and thus high cost for the manufacture of the suspensions, and above all lack of modularity of the said suspension, which will entail the requirement for specific interfaces.

### OBJECTS OF THE INVENTION

The present invention aims to propose a suspension device for dissociating the natural vibrations of the engine support structure from the frequencies covered by the excitation of the engine while it is running. This device must be able to be valid when running under either normal or problematic conditions.

The present invention aims also to propose a solution which makes it possible to moderate the loads tolerated by the attachments of the engine to the said engine support structure.

Finally, the present invention aims to propose a solution which is of increased modularity and which can consequently be adapted to any particular type of engine studied on a test bed.

### SUMMARY OF THE INVENTION

Usually, the suspensions for an engine on a test bed are suspensions to which the engine is directly attached. The present invention aims to propose a solution which comprises a set of members having elastic behaviour, which provide the connection between the engine support structure and the frame for attaching the fixed structure of the test bed.

Advantageously, at least one of the said members comprises an elastomeric material such as a natural or synthetic rubber. This elastomer may be crosslinked or non-crosslinked, charged or uncharged elastomer.

In a particularly advantageous manner, a solution may be proposed for a suspension in the form of several modules, each module comprising a set of members having elastic behaviour, which provide the connection between the engine support structure and the frame for attaching the fixed structure of the test bed, and in which at least one of the members comprises an elastomeric material.

This will make it possible to obtain greater flexibility of the system by optionally varying the number of modules per suspension, while at the same time allowing reduced bulk and a lower production cost compared with the solutions proposed in the prior art.

Proposing a modular suspension makes it possible to adapt the said suspension as a function of the type of engine tested.

Proposing a modular suspension also makes it possible to adapt the said suspension to the maximum load which the said suspension must withstand (for example 80 tonnes, which is the load corresponding to the breaking of a blade in the case of a conventional turbojet engine).

In a particularly advantageous manner, the member having the elastic behaviour consists of an elastomeric material in the form of a block, preferably a cylindrical block, which can be, for example, in the shape of a bush. This member is arranged around a nozzle and is enclosed in a metal collar to protect the said block. The said nozzle is then force-fitted onto two independent axles or shafts.

Each of the axles or shafts will be solidly attached to a member which allows fixing to the fixed frame of the test bed, whereas the said block of elastomeric material is solidly attached to two half-members which will be fixed to the engine support structure.

In a particularly advantageous manner, the elastomeric material of the block is prestressed before it is enclosed in the metal collar covering it. It is thus observed that this type of suspension may withstand both transverse and longitudinal loads, and even vertical loads.

The solution according to the present invention additionally makes it advantageously possible to treat the attachments of the said engine to the engine support frame moderately.

In a particularly advantageous manner, the suspension devices as describe above can be used for ground tests of turbojet engines or turboprop engines.

### BRIEF DESCRIPTION OF THE DRAWINGS

FIG. 1 represents a schematic view of a test bed on which an engine such as a turbojet engine is inspected.

FIG. 2 represents a cross section view of a constituent member of a suspension according to the present invention.

FIGS. 3a and 3b represent sets of several modules constituting a suspension according to the present invention.

### DESCRIPTION OF A PREFERRED EMBODIMENT OF THE INVENTION

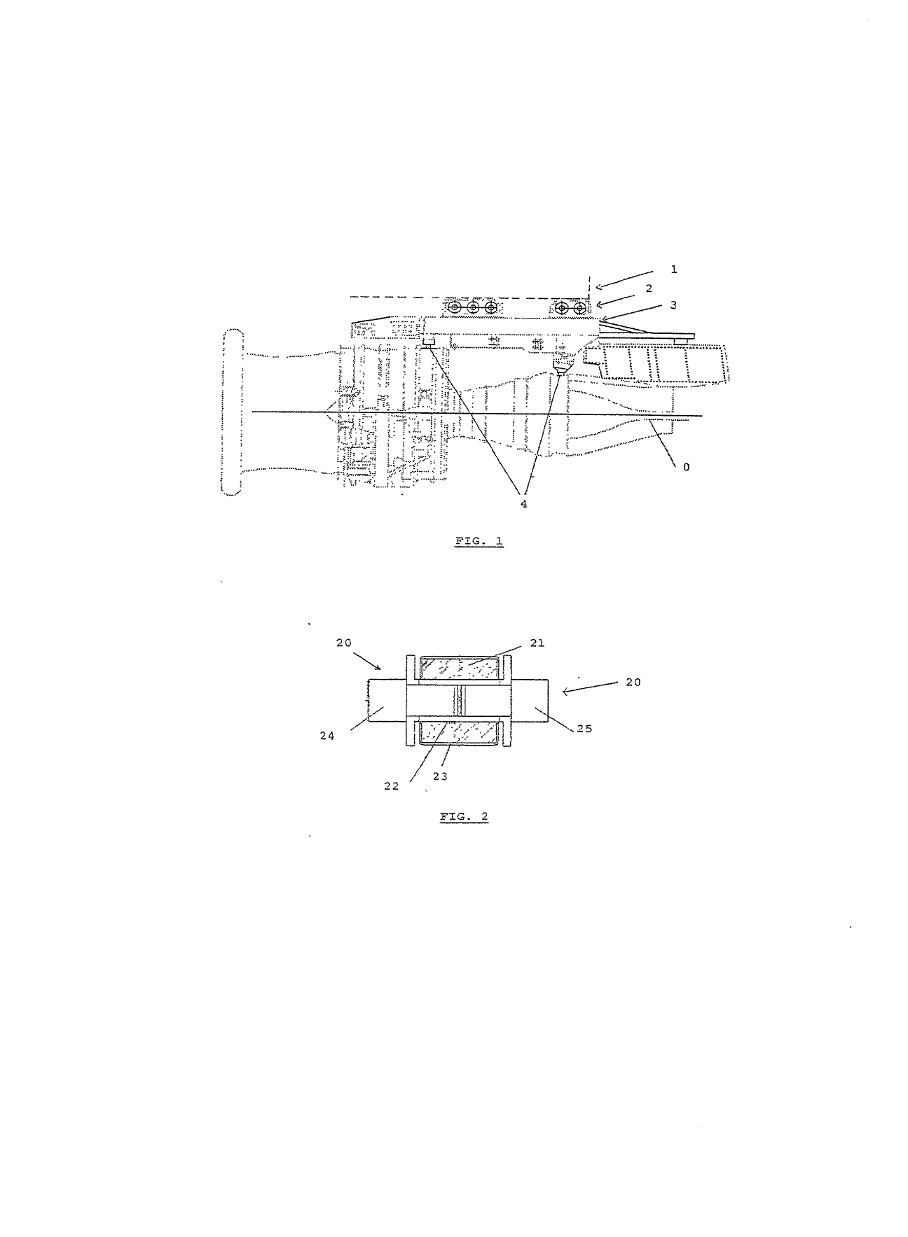

FIG. 1 represents a portion of the test bed which corresponds essentially to a structure 3 which is the support structure for the engine to be tested, while the fixed frame 1 of the test bed itself is represented only schematically.

This engine support structure 3 must be deformable and able to withstand any possible impacts, in particular in the case of behaviour under problematic conditions. For example, this structure must be able to withstand the load produced by the breaking of a blade of the turbojet engine.

The engine to be studied, for example a turbojet engine 0, is fixed to the engine support structure 3 and held there by fastenings 4.

The present invention aims to propose, as a device for connecting between the engine support structure 3 and the test bed frame, a modular suspension 2.

By virtue of this type of suspension, the natural vibrations of the engine and of the engine support structure 3 will be dissociated rather than transmitted to the test bed, both when running normally and when running under problematic conditions (such as the breaking of a fan rotor blade or the blocking of the rotor).

In addition, this solution makes it possible in a particularly advantageous manner to treat the fastenings 4 of the engine 0 to the engine support structure 3 moderately.

FIG. 2 represents a cross section view of a constituent member of such a suspension.

This member 20 advantageously has elastic behaviour and comprises an elastomeric block 21, which is preferably cylindrical in shape and is more particularly in the shape of a bush. This member is hollowed at its centre and is arranged around a nozzle 22 and enclosed in a metal collar 23 which allows the said elastomeric block 21 to be protected against an occasionally aggressive environment.

The said nozzle 22 is then force-fitted onto two independent axles 24 and 25.

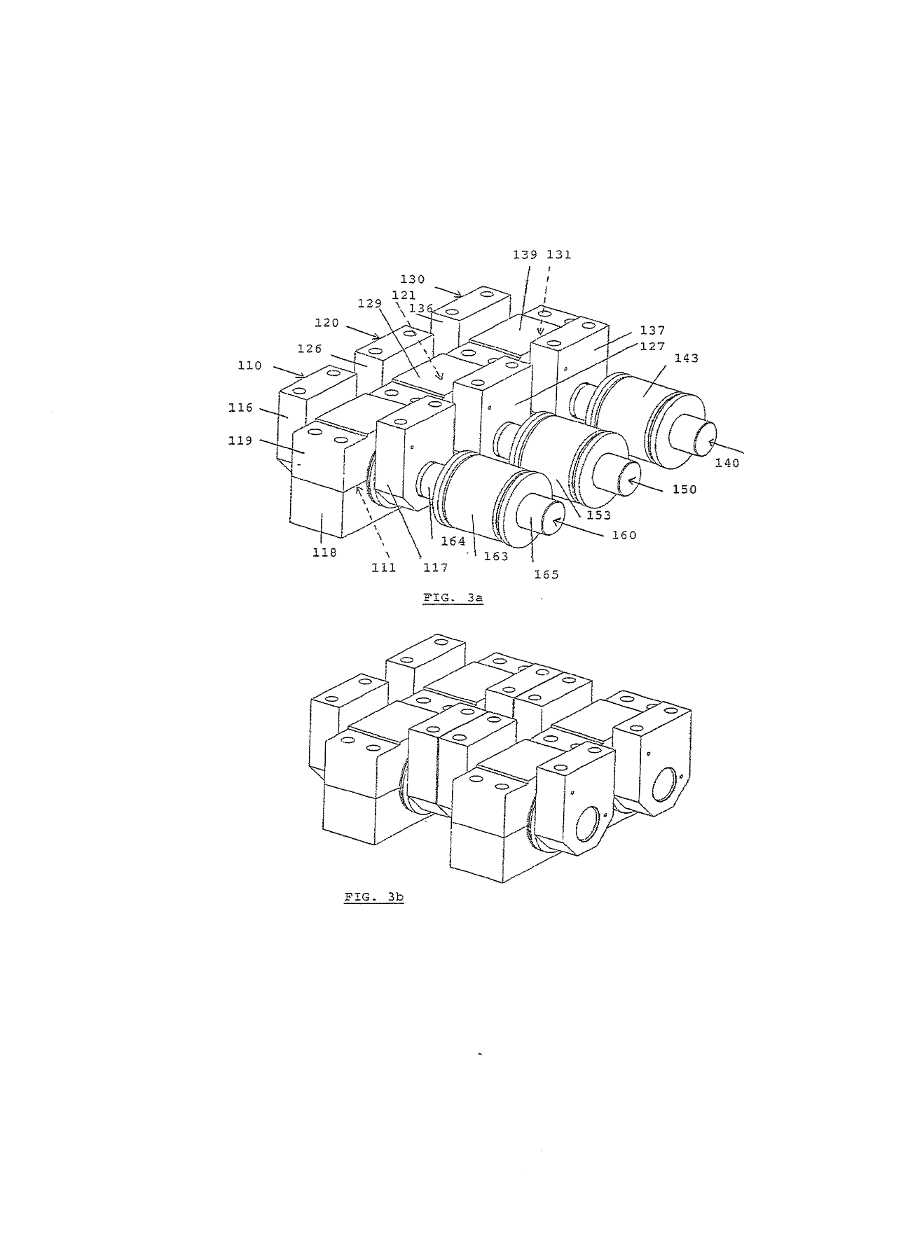

The FIG. 3 represent a set of several modules constituting a suspension according to the present invention. FIG. 3a represents a six-module suspension, whereas FIG. 3b represents a four-module suspension.

In FIG. 3a, three modules 110, 120 and 130 are represented in full, whereas for the three modules 140, 150 and 160, only the member providing the elastic function is represented, which is the block of elastomeric material covered by its sheath 143, 153 and 163. Each of these members is made up as represented in FIG. 2.

In order to allow the said suspension to be attached, on the one hand, to the fixed frame of the test bed, and, on the other hand, to the engine support structure, a fixing member 116, 126, 136, etc. or 117, 127, 137, etc. is provided, as represented for the modules 110, 120 and 130, this fixing member fitting onto each axle or shaft (not visible) of the member providing the elastic function 111, 121 and 131 (not visible). It is a totally solid attachment with no degree of freedom of movement of the axles.

Moreover, the member providing the elastic function, consisting of the block of elastomeric material 11, 12, 13 (not visible), is itself enclosed in two fixing half-members 118 and 119, 128 and 129, 138 and 139, etc.

In FIG. 3b, the four modules have been represented in full.

What is claimed is:

1. An apparatus for testing an engine, comprising:
a test bed comprising a fixed frame and an engine support structure; and
a suspension device disposed between said fixed frame and said engine support structure, said suspension device comprising at least one member having elastic behavior.

2. The apparatus of claim 1, wherein said at least one member having elastic behavior comprises at least one block made of an elastomeric material.

3. The apparatus of claim 1, comprising a plurality of members having elastic behavior, said plurality of members having elastic behavior being disposed in a plurality of modules such that each module comprises at least one member having elastic behavior.

4. The suspension device of claim 2, wherein the elastomeric material of said block is selected from the group consisting of crosslinked, non-crosslinked, charged, or uncharged elastomers.

5. The suspension device of claim 2, wherein said block is cylindrical and hollow at its center.

6. The apparatus of claim 2, further comprising:
a nozzle; and
a metal collar;
wherein said block is arranged around said nozzle, and said block is enclosed in said metal collar, said metal collar protecting said block.

7. The suspension device of claim 4, further comprising two independent axles, wherein said nozzle is force-fit onto said independent axles.

8. The suspension device of claim 2, wherein said elastomeric material is prestressed.

9. The suspension device of claim 7, wherein said independent axles are each attached to a fixing member, said fixing member being fixed to the fixed frame of said test bed.

10. The suspension device of claim 2, wherein said block is attached to two fixing half-members, said fixing half-members being fixed to said engine support structure.
